(19) United States
(12) Patent Application Publication
(10) Pub. No.: US 2009/0119379 A1
(43) Pub. Date: May 7, 2009

(54) Rendering of multi-media content to near bit accuracy by contractual obligation

(75) Inventors: Chris Read, San Diego, CA (US); Robert L. Hardacker, Escondido, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Sony Electronics Inc.

(21) Appl. No.: 11/982,885

(22) Filed: Nov. 5, 2007

(51) Int. Cl. G06F 15/16

(52) U.S. Cl. 709/206

(57) ABSTRACT

An embodiment of the present invention includes a technique to identify a piece of content. A content identifier is embedded into the piece of content in a pre-determined format. The content identifier identifies the content. The content embedded with the content identifier is encoded into a packaged content to be transmitted from a content provider to a content delivery operator via a transmission medium. The packaged content is delivered to a subscriber by the content delivery operator free of obfuscation according to a contractual agreement between the content provider and the content delivery operator such that the content identifier is preserved for identification of the content.

In another embodiment, an interface to a delivering unit receives a piece of content embedded with a content identifier in a pre-determined format. The content identifier identifies the content. The content is transmitted from a content provider to a content delivery operator and delivered by the content delivery operator free of obfuscation according to a contractual agreement between the content provider and the content delivery operator such that the content identifier is preserved for identification of the content. The content identifier is extracted from the piece of content according to the pre-determined format.

### BACKGROUND

1. Field of the Invention

Embodiments of the invention relate to the field of content delivery, and more specifically, to content identification.

2. Description of Related Art

With the development of broadband technologies, cable and satellite television services have become increasingly popular. Content delivery operators (e.g., cable operators, or multiple services/systems operator (MSO)) receive media content such as movies, feature content, television (TV) shows, etc. from content providers and transmit or deliver content to a viewer or subscriber.

When the content is delivered and rendered on a display or playback device, such as a TV set, it is useful to be able to identify the content. However, typically, the content delivery operator may obfuscate or modify the content by employing techniques that make it difficult to determine the specific content.

### BRIEF DESCRIPTION OF THE DRAWINGS

Embodiments of the invention may best be understood by referring to the following description and accompanying drawings that are used to illustrate embodiments of the invention. In the drawings:

FIG. 1 is a diagram illustrating a system according to one embodiment of the invention.

FIG. 2 is a diagram illustrating the content packaging unit according to one embodiment of the invention.

FIG. 3 is a diagram illustrating the receiving device according to one embodiment of the invention.

FIG. 4 is a flowchart illustrating a process to perform content packaging according to one embodiment of the invention.

FIG. 5 is a flowchart illustrating a process to perform extraction of content identifier according to one embodiment of the invention.

FIG. 6 is a diagram illustrating a content packaging unit and/or receiving device according to one embodiment of the invention

### DESCRIPTION

An embodiment of the present invention includes a technique to identify a piece of content. A content identifier is embedded into the piece of content in a pre-determined format. The content identifier identifies the content. The content embedded with the content identifier is encoded into a packaged content to be transmitted from a content provider to a content delivery operator via a transmission medium. The packaged content is delivered to a subscriber by the content delivery operator free of obfuscation according to a contractual agreement between the content provider and the content delivery operator such that the content identifier is preserved for identification of the content.

In another embodiment, an interface to a delivering unit receives a piece of content embedded with a content identifier in a pre-determined format. The content identifier identifies the content. The content is transmitted from a content provider to a content delivery operator and delivered by the content delivery operator free of obfuscation according to a contractual agreement between the content provider and the content delivery operator such that the content identifier is preserved for identification of the content. The content identifier is extracted from the piece of content according to the pre-determined format.

In the following description, numerous specific details are set forth. However, it is understood that embodiments of the invention may be practiced without these specific details. In other instances, well-known circuits, structures, and techniques have not been shown in order not to obscure the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

Embodiments of the invention include a technique to render multi-media content to near bit accuracy by contractual obligation. The technique includes embedding a content identifier in a piece of content so that it can be later retrieved for content identification. The piece of content may be a television program, a movie, a song, an album, a cartoon show, etc. It may be a piece of video content, a piece of audio content, a piece of feature content, a piece of documentary content, a broadcast program, a piece of video-on-demand (VOD) content, a multimedia file, or any other media content. The content may be provided by a content provider. The content provider embeds a content identifier in the piece of content. The content identifier may be any information that identifies the content. The content identifier may be inserted into the content in such a way that it does not cause any noticeable effect on the content. The content provider may transmit the content having the embedded content identifier to a content delivery operator over a transmission medium. The transmission medium may be any convenient medium such as broadcast (e.g., satellite, terrestrial, cable networks), Internet, wireless transmissions, or physical delivery of the content file such as digital versatile disk (DVD). The content delivery operator may be any entity that provides delivery service to subscribers or viewers. The content delivery operator may be a satellite operator, a cable operator, or a multiple services/systems operator (MSO).

To ensure that the content identifier is not destroyed or modified by the content delivery operator, the content provider may enter into a contractual agreement with the content delivery operator to obligate the content delivery operator to deliver the content free of obfuscation after the normal decoding. Such obfuscation may include processing of the content, scaling the content, shifting the content, altering the luminance or chrominance slightly, time contraction/expansion, etc. The content delivery operator may be obligated by the contractual agreement to provide the bit-accurate decoded content to the receiving device of the subscriber or viewer.

With the content identifier embedded in the piece of content not being modified or destroyed, post processing of the content at the receiving device may provide many opportunities to third party entities to provide further services to the subscribers or viewers. These opportunities may include advertisements, enhanced viewing experience, interactive video/audio, and other real-time operations. The third party entities may include manufacturers of receiving device such as television manufacturers, display monitor manufacturers, or computer system manufacturers. The third party entities may also include the content providers or the content delivery operators.

The content identifier may include any information that identifies or characterizes the content. The content identifier may duplicate some or all the metadata information that is included as part of the normal packaging of the content prior to transmission to the content delivery operator. The content identifier may include information such as serial number, identification number, temporal information (e.g., frame number, elapse time) location identifier, title, date of theatrical release, summary of plot, cast, and crew, Motion Picture Association of America (“MPAA”) rating, length, price per view, scheduling information, copyright information, etc. The content identifier may also be in any form. It may be a digital representation of visual data (e.g., image, graphics, video), audio data, or textual data.

The content identifier may be embedded in the piece of content in such a way that it does not cause any noticeable effect on perceptibility. For example, it may be inserted at a specified location in the piece of content, such as a specific row (e.g., bottom row, top row) or column (e.g., leftmost, rightmost) in an image frame. It may also be embedded in the content using any suitable watermarking techniques.

The content provider may encode the content with the embedded identifier in a normal manner for transmission to the content delivery operator. This may include packaging or encoding the content with metadata, error detection and correction code, or any other ancillary information. The content may be in compressed or uncompressed form. Metadata associated with the content may be included either with the compressed content (in-band metadata) or separately from the compressed content (out-of-band metadata). At the head-end administered by the content delivery operator, the packaged content may be unpacked or decoded accordingly. The decoded content may then be delivered to a delivery unit such as a set-top box (STB) at the receiving device (e.g., television set). Under the obligatory agreement, the content delivery operator provides bit-accurate decoded content free of obfuscation. The bit-accurate decoded content is provided over a high definition multimedia interface (HDMI) or an equivalent digital interface. Therefore, the content received at the receiving device contains the unmodified content identifier. The content identifier may then be extracted or retrieved from the content for further processing. Alternatively or additionally, the content delivery operator may forward the metadata associated with the content to the receiving device.

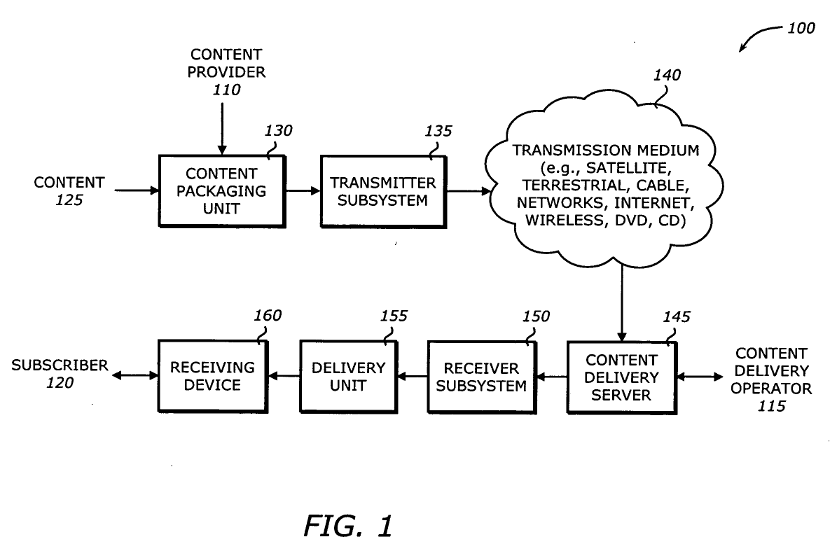

FIG. 1 is a diagram illustrating a system 100 according to one embodiment of the invention. The system 100 includes a content packaging unit 130, a transmitter subsystem 135, a transmission medium 140, a content delivery server 145, a receiver subsystem 150, a delivery unit 155, and a receiving device 160. The system 100 may include more or less than the above components.

The content packaging unit 130 packages a piece of content 125 into packaged content to be delivered to a plurality of subscribers including a subscriber 120. The content package unit 130 may be operated by a content provider 110. The content provider 110 may be an entity, an individual, or a business organization that provides or distributes the content 125. The piece of content may be a piece of video content, a piece of audio content, a piece of feature content, a piece of documentary content, a broadcast program, a piece of video-on-demand (VOD) content, a multimedia file, or any other media content. The content packaging unit 130 prepares, stages, encodes, formats, or packages the content into the packaged content ready for transmission. In particular, the content packaging unit 130 embeds a content identifier to identify the content 125.

The transmitter subsystem 135 transmits the packaged content to the transmission medium 140 to the content delivery server 145. The transmitter subsystem 135 may include a packetizer to packetize the packaged content into packets or bit-stream. The transmitter subsystem 135 may include a modulator to modulate the bit-stream for transmission. The modulator may include vestigial sideboard (VSB) modulator, radio frequency (RF) up-converter, and transmitter to convert the stream into a signal to a transmitter station. The transmitter station may include a high-powered antenna to broadcast the signal containing the content. In one embodiment, the transmitter subsystem 135 may include a transport layer according to the Advanced Television Systems Committee (ATSC) standard. The ATSC transport layer is based on the Motion Pictures Experts Group (MPEG)-2 transport stream (TS) format, as defined by the MPEG-2 standard. The MPEG-2 TS provides a mechanism to encapsulate and multiplex coded video, coded audio, and generic data into a unified bit-stream.

The transmission medium 140 may be any medium suitable for transmitting the bit-stream of the packaged content to the content delivery server 145. It may include satellite or terrestrial-based media (e.g., cable networks), or physical delivery of packaged content in a form of mass media such as DVD, flash memory, compact disk (CD), etc. It may include a broadband network, a wired network, or a wireless network. The network may be the Internet, a wide area network (WAN), a local area network (LAN), a personal area network (PAN), or any other network that may be used for content transmission.

The content delivery server 145 may be a point of presence (PoP) operated by a content delivery operator 115. It receives the content transmitted via the transmission medium 140. The content delivery operator 115 may be a content distributor, a cable operator, or any content provider or system/service operator (MSO) that provides, delivers, or distributes the content to a number of content subscribers, including the subscriber 120.

The content provider 110 and the content delivery operator 115 may enter into a contractual agreement to obligate the content delivery operator to deliver the content free of obfuscation after the normal decoding such that the content identifier may be accurately recovered or extracted at the receiving end for additional processing. The contractual agreement may provide an exchange of services, a royalty payment, a licensing fee, or any other form of compensation agreeable to both parties. The contractual agreement or an authorization, may be digitally signed and embedded in the content. The content delivery operator 115, upon receiving the packaged content, may verify or authenticate the digital certificate certifying the contractual agreement. If the agreement is authenticated, the content delivery operator 115 may then proceed to perform the operations as required by the contract, such as providing bit-accurate decoded content. The bit-accurate decoded content is provided over the HDMI or an equivalent digital interface. Alternatively or additionally, the contract agreement may require the content delivery operator 115 to send the metadata information from the delivery unit 155 to the receiving device 160 so that metadata services may be performed.

The receiver subsystem 150 may include a receiver antenna to receive the broadcast signal, a demodulator to demodulate the RF signal to base-band signal, analog-to-digital converter to convert the analog signal into digital bitstream.

The delivery unit 155 delivers the received bit-stream containing the content to the receiving device 160. It may include a set-top box (STB) or integrated with the receiver subsystem 150 into a STB. The delivery unit 155 may include a decoder to decode the content to provide bit-accurate decoded content under the contractual agreement. The delivery unit 155 typically removes the metadata associated with the content 125 before delivery to the receiving device 160. However, as discussed above, the contract agreement may alternatively or additionally require the content delivery operator 115 to pass the metadata to the receiving unit 160.

The receiving device 160 may be any receiving device such as television (TV) display monitor, a flat-panel display, a computer, a wireless receiving device, or any device that may render, display, playback, or present the content to the subscriber or viewer 120. The receiving device 160 may include, or provide an interface to, a processing system that processes the delivered content to retrieve the content identifier to be used in an application that may enhance further the viewing or listening experience of the subscriber 120. The receiving device 160 may also have interface to a network so that access to a metadata database may be possible.

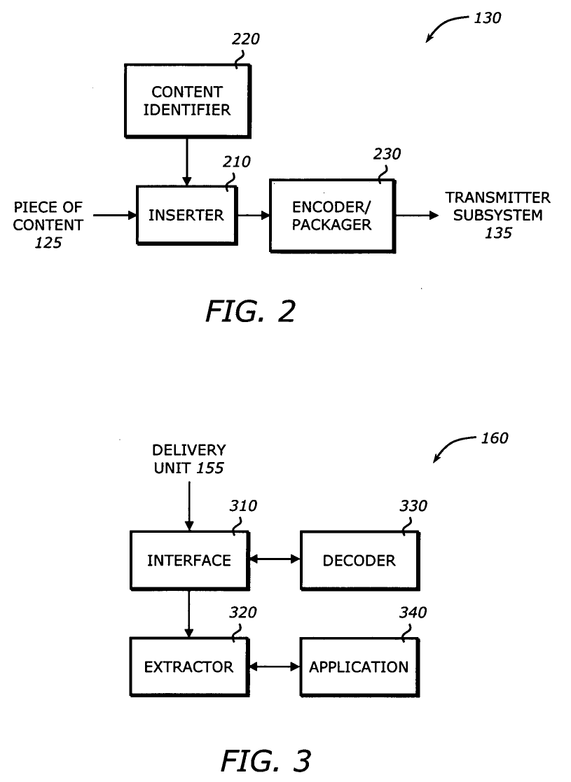

FIG. 2 is a diagram illustrating the content packaging unit 130 shown in FIG. 1 according to one embodiment of the invention. The content packaging unit 130 includes an inserter 210 and an encoder/packager 230. The content packaging unit 130 may include more or less than the above components. Furthermore, any of the components of the content packaging unit 130 may be implemented by hardware, software, firmware, or any combination of the above.

The inserter 210 embeds a content identifier 220 into the piece of content 125 in a pre-determined format. The pre-determined format may include a specified or designated location in the content or a watermarking, data hiding, or stenographic procedure. The content identifier 220 identifies the content. The content identifier 220 may include information such as serial number, identification number, temporal information (e.g., frame number, elapse time) location identifier, title, date of theatrical release, summary of plot, cast, and crew, MPAA rating, length, price per view, scheduling information, copyright information, etc. The content identifier 220 may also be in any form. It may be a digital representation of visual data (e.g., image, graphics, video), audio data, or textual data. The content identifier 220 may duplicate the information included in the metadata as part of the packaged content. Normally, the metadata information is stripped off or removed from the content by the delivery unit 155 or a content delivery server 145, and therefore information regarding the content 125 may no longer be available at the receiving device 160. The content identifier 220 therefore provides a way to allow applications to obtain information regarding the content at the receiving device 160. As discussed earlier, alternatively or additionally, the metadata associated with the piece of content 125 may be forwarded to the receiving unit 160 for metadata services.

There are a number of techniques to embed the content identifier 220 into the content 125. The inserter 210 may insert the content identifier 220 into the content 125 to maintain high imperceptibility, robustness, and security. It may insert the content identifier 220 into the content 125 at specified locations without causing noticeable effect on the content. These locations may include a specific row (e.g., bottom row, top row) or column (e.g., leftmost, rightmost) in an image frame of the content. The locations may also include the least significant bits (LSBs) of designated words representing the content such as pixels in an image.

The inserter 210 may watermark the content 125 with the content identifier 220. Any suitable digital watermarking techniques may be employed. These techniques may include public watermarking, blind watermarking, semi-blind watermarking, private watermarking, non-blind watermarking, or asymmetric watermarking. A key may be used to generate a random sequence during the embedding process. The technique may be based on spatial or frequency domain. It may use robust or fragile digital watermarking techniques.

The encoder/packager 230 encodes the content embedded with the content identifier into a packaged content to be transmitted from the content provider 110 to the content delivery server 145 via the transmission medium 140. The encoder/packager 230 may encode the content according to a video coding standard. The video coding standard can provide a bit-accurate decode of the content. Examples of these coding standards may include Advanced Video Coding (AVC), or MPEG-4, Video Coding (VC)-1, MPEG-2, etc. In addition, the encoder/packager 230 may include error detection and correction code. The encoder/packager 230 may also include metadata information associated with the content 125.

The packaged content is delivered to the subscriber 120 by the content delivery operator 115 free of obfuscation according to a contractual agreement between the content provider 110 and the content delivery operator 115 such that the content identifier 220 is preserved for identification of the content 125.

FIG. 3 is a diagram illustrating the receiving device 160 shown in FIG. 1 according to one embodiment of the invention. The receiving device 160 includes an interface 310, an extractor 320, a decoder 330, and an application 340. The receiving device 160 may include more or less than the above components. For example, the decoder 330 may be optional and may be included in the delivery unit 155. Furthermore, any of the components of the receiving device 160 may be implemented by hardware, software, firmware, or any combination of the above. For brevity and clarity, components related to user interface, display, or playback functions are not shown.

The receiving device 160 may be a display device that displays the content 125 for viewing. It may also be a processing device that is interfaced to a display device. The display device may be a TV set, a display monitor, a flat panel display, a computer monitor, etc. The receiving device 160 may be a unit integrated with the delivery unit 155. It may be a desktop computer, a digital personal assistant (PDA), a hand-held device, a mobile device, a multimedia playback device, an audio playback device, or any other device that is configured to present the content to the subscriber 120.

The interface 310 is interfaced to the delivering unit 155 to receive the piece of content 125 embedded with the content identifier 220 in the pre-determined format. As discussed above, the content identifier 220 identifies the content 125. The piece of content 125 is transmitted from the content provider 110 to the content delivery server 145 and delivered by the content delivery operator 115 free of obfuscation according to a contractual agreement between the content provider 110 and the content delivery operator 115 such that the content identifier 220 is preserved for identification of the content 125. The interface 310 may be interfaced to a HDMI medium, or any other content interface standard.

The extractor 320 extracts the content identifier 220 from the piece of content 125 according to the pre-determined format. Since the pre-determined format is known and typically made available by the content provider 110, a third-party entity may develop algorithms or method to obtain the content identifier 220 using this pre-determined format. For example, if the content identifier 220 is embedded in the piece of content 125 at specified locations (e.g., top row, leftmost column), then the extractor 320 extracts the content identifier 220 from the piece of content 125 at these specified locations. Similarly, the extractor 320 may retrieve the content identifier 220 from the piece of content 125 according to a watermarking procedure that is compatible to the watermarking procedure employed in the content packaging unit 130 (FIG. 1). In general, the extractor 320 performs an operation that is the reverse of the operation performed by the inserter 210 (FIG. 2).

The decoder 330 decodes the content as received from the delivery unit 155. It may decode according to a coding standard such as the AVC or VC-1. The video coding standard can provide a bit-accurate decode of the content. It may also perform error checking. If the decoding function is performed in the delivery unit 155, such as the STB, then the decoder 330 may not be needed.

The application 340 may be an application that uses the extracted content identifier 220 as part of the post processing of the content 125. It may provide an interface to an external device that utilizes the extracted content identifier 220. The application 340 may include modules to enhance the functionalities of the content 125. For example, it may include advertisement insertions, interactive functions, etc. The application 340 may have interface to a metadata database to provide metadata services.

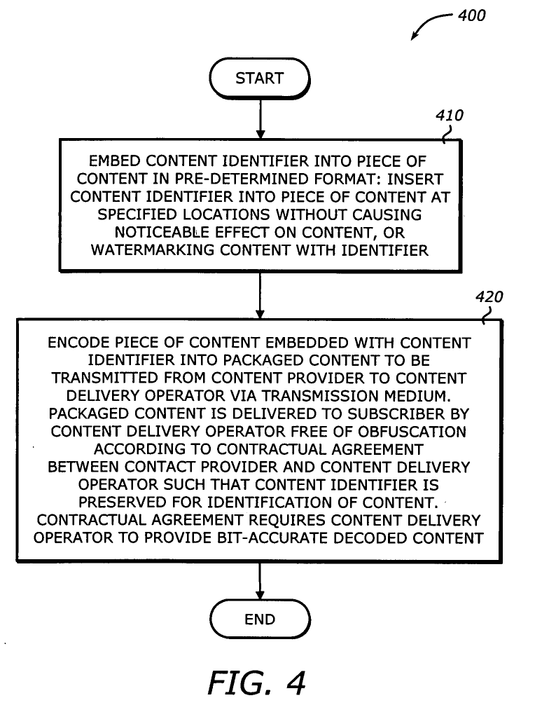

FIG. 4 is a flowchart illustrating a process 400 to perform content packaging according to one embodiment of the invention.

Upon START, the process 400 embeds a content identifier into a piece of content in a pre-determined format (Block 410). The content identifier identifies the content. The piece of content may be a television program, a movie, a song, an album, a cartoon show, etc. This may be performed by inserting the content identifier into the piece of content at specified locations without causing noticeable effect on the content, or watermarking the content with the content identifier.

Next, the process 400 encodes the piece of content embedded with the content identifier into a packaged content to be transmitted from a content provider to a content delivery operator via a transmission medium (Block 420). The encoding the content may be performed according to a video coding standard, such as AVC or VC-1. The video coding standard can provide a bit-accurate decode of the content. The packaged content is delivered to a subscriber by the content delivery operator free of obfuscation according to a contractual agreement between the content provider and the content delivery operator such that the content identifier is preserved for identification of the content. The contractual agreement requires the content delivery operator to provide bit-accurate decoded content. The bit-accurate decoded content may be provided over the HDMI or an equivalent digital interface. The process 400 is then terminated.

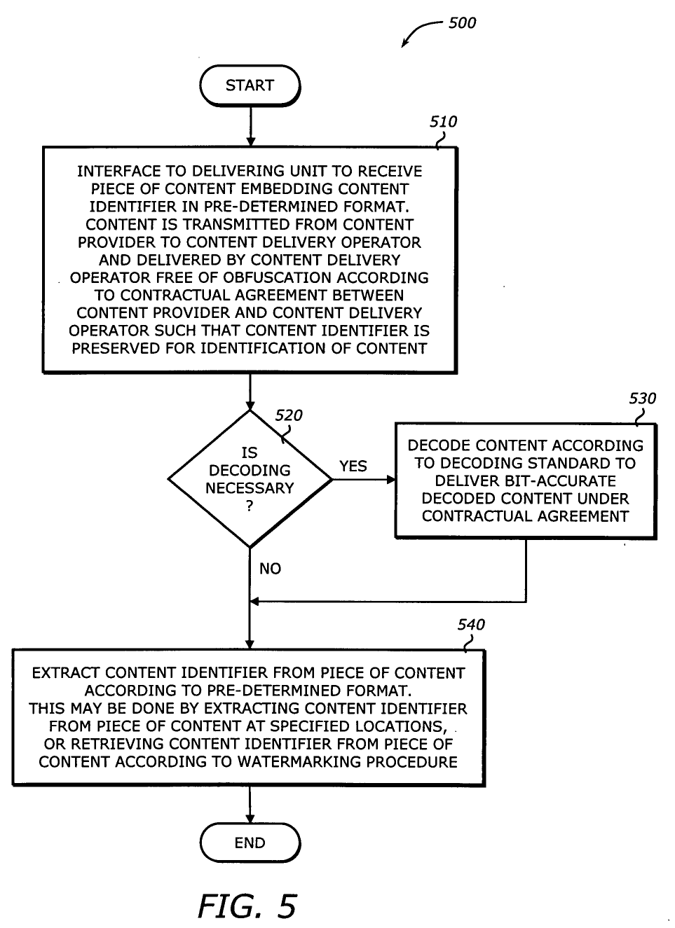

FIG. 5 is a flowchart illustrating a process 500 to perform extraction of content identifier according to one embodiment of the invention.

Upon START, the process 500 interfaces to a delivering unit to receive a piece of content embedded with a content identifier in a pre-determined format (Block 510). The content identifier identifies the content. The content is transmitted from a content provider to a content delivery operator and delivered by the content delivery operator free of obfuscation according to a contractual agreement between the content provider and the content delivery operator such that the content identifier is preserved for identification of the content. Then, the process 500 determines if decoding is needed (Block 520). If not, the process 500 proceeds to Block 540. Otherwise, the process 500 decodes the content according to a decoding standard to deliver bit-accurate decoded content under the contractual agreement (Block 530).

Next, the process 500 extracts the content identifier from the piece of content according to the pre-determined format (Block 540). This may be performed by extracting the content identifier from the piece of content at specified locations, or retrieving the content identifier from the piece of content according to a watermarking procedure. The process 500 is then terminated.

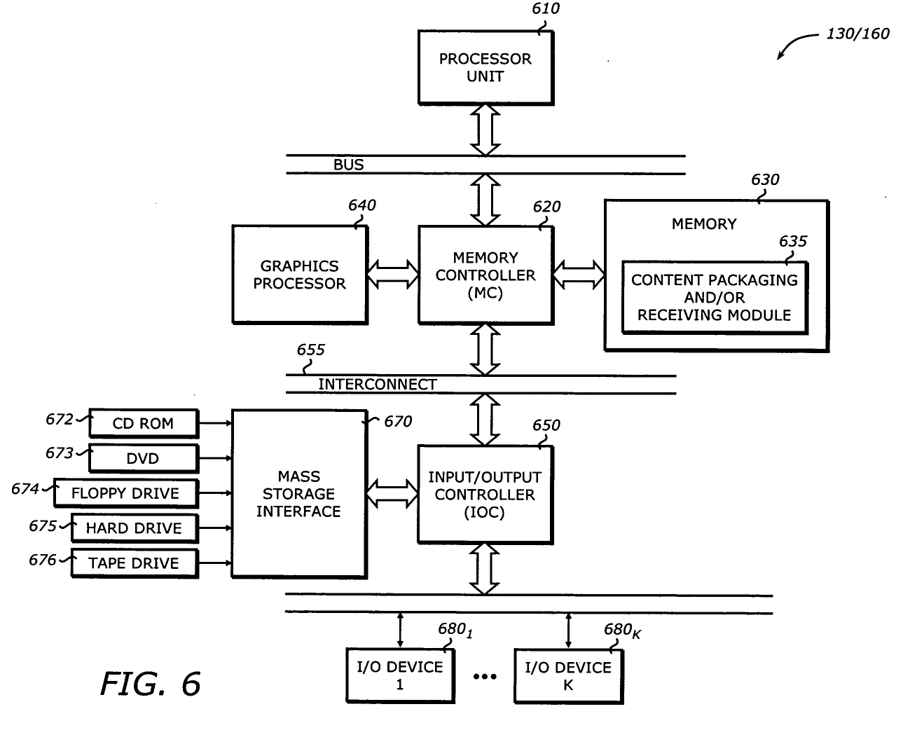

FIG. 6 is a diagram illustrating the content packaging unit 130 and/or the receiving device 160 shown in FIGS. 2 and 3, respectively, according to one embodiment of the invention. The content packaging unit 130 and/or the receiving device 160 includes a processor unit 610, a memory controller (MC) 620, a main memory 630, a graphics processor 640, an input/output controller (IOC) 650, an interconnect 655, a mass storage interface 670, and input/output (I/O devices 680₁ to 680_{K}. The content packaging unit 130 and/or the receiving device 160 may contain more or less than the above components.

The processor unit 610 represents a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The MC 620 provides control and configuration of memory and input/output devices such as the main memory 630 and the IOC 640. The MC 620 may be integrated into a chipset that integrates multiple functionalities such as graphics, media, isolated execution mode, host-to-peripheral bus interface, memory control, power management, etc. The MC 620 or the memory controller functionality in the MCH 620 may be integrated in the processor unit 610. In some embodiments, the memory controller, either internal or external to the processor unit 610, may work for all cores or processors in the processor unit 610. In other embodiments, it may include different portions that may work separately for different cores or processors in the processor unit 610.

The main memory 630 stores system code and data. The main memory 630 is typically implemented with dynamic random access memory (DRAM), static random access memory (SRAM), or any other types of memories including those that do not need to be refreshed. The main memory 630 may include multiple channels of memory devices such as DRAMs. The main memory 630 may include a content packaging and/or a receiving module 635. The content packaging and/or a receiving module 635 includes program instructions and data to perform content packaging and/or receiving functions.

The graphics processor 640 is any processor that provides graphics functionalities. The graphics processor 640 may also be integrated into the MC 620 to form a Graphics and Memory Controller (GMC). The graphics processor 640 may be a graphics card such as the Graphics Performance Accelerator (AGP) card, interfaced to the MC 620 via a graphics port such as the Accelerated Graphics Port (AGP) or a peripheral component interconnect (PCI) Express interconnect. The graphics processor 640 provides interface to an external display device such as standard progressive scan monitor, television (TV)-out device, and Transition Minimized Differential Signaling (TMDS) controller.

The IOC 650 has a number of functionalities that are designed to support I/O functions. The IOC 650 may also be integrated into a chipset together or separate from the MC 620 to perform I/O functions. The IOC 650 may include a number of interface and I/O functions such as peripheral component interconnect (PCI) bus interface, processor interface, interrupt controller, direct memory access (DMA) controller, power management logic, timer, system management bus (SMBus), universal serial bus (USB) interface, mass storage interface, low pin count (LPC) interface, wireless interconnect, direct media interface (DMI), etc.

The interconnect 655 provides interface to peripheral devices. The interconnect 655 may be point-to-point or connected to multiple devices. For clarity, not all interconnects are shown. It is contemplated that the interconnect 655 may include any interconnect or bus such as Peripheral Component Interconnect (PCI), PCI Express, Universal Serial Bus (USB), Small Computer System Interface (SCSI), serial SCSI, and Direct Media Interface (DMI), etc.

The mass storage interface 670 interfaces to mass storage devices to store archive information such as code, programs, files, data, and applications. The mass storage interface may include SCSI, serial SCSI, Advanced Technology Attachment (ATA) (parallel and/or serial), Integrated Drive Electronics (IDE), enhanced IDE, ATA Packet Interface (ATAPI), etc. The mass storage device may include compact disk (CD) read-only memory (ROM) 672, digital versatile disc (DVD) 673, floppy drive 674, hard drive 675, tape drive 676, and any other magnetic or optic storage devices. The mass storage device provides a mechanism to read machine-accessible media.

The I/O devices 680₁ to 680_{K} may include any I/O devices to perform I/O functions. Examples of I/O devices 680₁ to 680_{K} include controller for input devices (e.g., keyboard, mouse, trackball, pointing device, and remote control unit), media card (e.g., audio, video, and graphic), network card, and any other peripheral controllers.

Elements of one embodiment of the invention may be implemented by hardware, firmware, software or any combination thereof. The term hardware generally refers to an element having a physical structure such as electronic, electromagnetic, optical, electrooptical, mechanical, electro-mechanical parts, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory, ROM, EPROM). Examples of firmware may include microcode, writable control store, micro-programmed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read only memory (ROM), a flash memory, an erasable programmable ROM (EPROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include information or data that, when accessed by a machine, cause the machine to perform the operations or actions described above. The machine accessible medium may also include program code embedded therein. The program code may include machine readable code to perform the operations or actions described above. The term “information” or “data” here refers to any type of information that is encoded for machine-readable purposes. Therefore, it may include program, code, data, file, etc.

All or part of an embodiment of the invention may be implemented by hardware, software, or firmware, or any combination thereof. The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
embedding a content identifier into a piece of content in a pre-determined format, the content identifier identifying the content; and
encoding the content embedded with the content identifier into a packaged content to be transmitted from a content provider to a content delivery operator via a transmission medium, the packaged content being delivered to a subscriber by the content delivery operator free of obfuscation according to a contractual agreement between the content provider and the content delivery operator such that the content identifier is preserved for identification of the content.

2. The method of claim 1 wherein embedding the content identifier comprises:
inserting the content identifier into the piece of content at specified locations without causing noticeable effect on the content.

3. The method of claim 1 wherein embedding the content identifier comprises:
watermarking the content with the content identifier.

4. The method of claim 1 wherein the contractual agreement requires the content delivery operator to provide bit-accurate decoded content.

5. The method of claim 4 wherein the bit-accurate decoded content is provided over a high definition multimedia interface (HDMI) or an equivalent digital interface.

6. The method of claim 1 wherein encoding the content comprises:
encoding the content according to a video coding standard.

7. The method of claim 6 wherein the video coding standard provides a bit-accurate decode of the content.

8. The method of claim 1 wherein the piece of content includes a piece of video content, a piece of audio content, a piece of feature content, a piece of documentary content, a broadcast program, a piece of video-on-demand (VOD) content, or a multimedia file.

9. A method comprising:
interfacing to a delivering unit to receive a piece of content embedded with a content identifier in a pre-determined format, the content identifier identifying the content, the content being transmitted from a content provider to a content delivery operator and delivered by the content delivery operator free of obfuscation according to a contractual agreement between the content provider and the content delivery operator such that the content identifier is preserved for identification of the content; and
extracting the content identifier from the content according to the pre-determined format.

10. The method of claim 9 wherein interfacing comprises:
interfacing to a set-top box (STB).

11. The method of claim 9 wherein interfacing comprises:
interfacing to a high definition multimedia interface (HDMI) medium.

12. The method of claim 9 wherein extracting comprises:
extracting the content identifier from the piece of content at specified locations.

13. The method of claim 9 wherein extracting comprises:
retrieving the content identifier from the piece of content according to a watermarking procedure.

14. The method of claim 9 wherein the content includes a piece of video content, a piece of audio content, a piece of feature content, a piece of documentary content, a broadcast program, a piece of video-on-demand (VOD) content, or a multimedia file.

15. The method of claim 9 further comprising:
decoding the content according to a decoding standard to deliver bit-accurate decoded content under the contractual agreement.

16. An article of manufacture comprising:
a machine-accessible storage medium including information that, when accessed by a machine, cause the machine to perform operations comprising:
embedding a content identifier into a piece of content in a pre-determined format, the content identifier identifying the content; and
encoding the content embedded with the content identifier into a packaged content to be transmitted from a content provider to a content delivery operator via a transmission medium, the packaged content being delivered to a subscriber by the content delivery operator free of obfuscation according to a contractual agreement between the content provider and the content delivery operator such that the content identifier is preserved for identification of the content.

17. The article of manufacture of claim 16 wherein the information causing the machine to perform embedding the content identifier comprises information that, when accessed by a machine, cause the machine to perform operations comprising:
inserting the content identifier into the piece of content at specified locations without causing noticeable effect on the content.

18. An apparatus comprising:
an inserter to embed a content identifier into a piece of content in a pre-determined format, the content identifier identifying the content; and
an encoder coupled to the inserter to encode the content embedded with the content identifier into a packaged content to be transmitted from a content provider to a content delivery operator via a transmission medium, the packaged content being delivered to a subscriber by the content delivery operator free of obfuscation according to a contractual agreement between the content provider and the content delivery operator such that the content identifier is preserved for identification of the content.

19. The apparatus of claim 18 wherein the inserter inserts the content identifier into the piece of content at specified locations without causing noticeable effect on the content.

20. The apparatus of claim 18 wherein the contractual agreement requires the content delivery operator to provide bit-accurate decoded content.

21. The apparatus of claim 20 wherein the bit-accurate decoded content is provided over a high definition multimedia interface (HDMI) or an equivalent digital interface.

22. The apparatus of claim 18 wherein the encoder encodes the content according to a video coding standard that provides a bit-accurate decode of the content.

23. An apparatus comprising:
an interface to a delivering unit to receive a piece of content embedded with a content identifier in a pre-determined format, the content identifier identifying the content, the content being transmitted from a content provider to a content delivery operator and delivered by the content delivery operator free of obfuscation according to a contractual agreement between the content provider and the content delivery operator such that the content identifier is preserved for identification of the content; and
an extractor coupled to the interface to extract the content identifier from the content according to the pre-determined format.

24. The apparatus of claim 23 wherein the interface interfaces to one of a set-top box (STB) and a high definition multimedia interface (HDMI) medium.

25. The apparatus of claim 23 wherein the extractor extracts the content identifier from the piece of content at specified locations.
